(19) United States
(12) Patent Application Publication
(10) Pub. No.: US 2007/0028702 A1
(43) Pub. Date: Feb. 8, 2007

(54) Seat load detecting apparatus

(75) Inventors: Kazunori Sakamoto, Chiryu-shi (JP); Hitoshi Takayanagi, Chiryu-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEKI KABUSHIKI KAISHA, Kariya-shi (JP)

(21) Appl. No.: 10/558,580

(22) PCT Filed: Jul. 27, 2004
(86) PCT No.: PCT/JP04/10655

§ 371 Date: Nov. 30, 2005

(30) Foreign Application Priority Data
Jul. 30, 2003 (JP) 2003-282992

(51) Int. Cl. G01L 1/04

(52) U.S. Cl. 73/862.621

(57) ABSTRACT

A seat load detecting apparatus 10 for detecting a load acting on a seat 1, using load detecting means 21, 31, 40 and 49, in which latching rods 15 and 16 for lining up and latching one end of a plurality of cushion springs 17 and 27 that give cushioning to the seat 1 are provided in a seat cushion frame 11 that forms a seat skeleton, with a flexible member 21 arranged between the latching rod 15 and the seat cushion frame 11.

### TECHNICAL FIELD

The present invention relates to a seat load detecting apparatus for detecting a load acting on a seat, and in particular, relates to a seat load detecting apparatus in which a load sensor is provided inside a frame that constitutes a seat skeleton.

### BACKGROUND ART

Conventionally, in the field of vehicles, in order to detect whether or not an occupant is seated on a seat by detecting a load acting on a seat cushion, cushion springs that give cushioning are disposed inside a seat cushion frame that forms a seat skeleton, the cushion springs are laid out across the seat cushion frame by springs from the left and right of a seat pan of the seat, and a load sensor is arranged on a member thereof (for example, see patent document 1).

In the above mentioned publication, the load sensor is fixed by a bolt to the inner side of the side portion of the seat cushion frame. The cushion springs have spring lines laid out on a plane lengthwise and breadthwise, and are formed of main members and a plurality of sub-members (coil springs) attached to the main members on their outer sides. The sub-members, which are the coil springs, have one end latched to the seat pan on either left or right side, respectively, of the main members, and the other end is latched to the seat cushion frame.

The configuration is such that when a person sits on the seat and a load acts on the seat cushion, the sub-members flex, so that the load sensor detects a pulling force from the sub-members. In such cases, in order that the flexure of one of the plurality of sub-members is detected, the load sensor is arranged at one sub-member.

Patent document reference 1: JP 2001-180353A

### DISCLOSURE OF INVENTION

Problem to be Solved by the Invention

Conventionally, however, as in the above described publication, in a configuration in which the load sensor is arranged at one of the sub-members, part of the load acting on the cushion springs is detected by the load sensor, so that when a person sits on the seat, since the load acting on the cushion springs escapes to the seat cushion frame from locations other than sub-members to which the load sensor is connected, load detection cannot be performed with good accuracy. Therefore, although it would be desirable to arrange a load sensor for each cushion spring in order to perform load detection with good accuracy, costs would increase.

Thus, in view of the above described problems, the present invention has as a task the provision of a configuration in which load detection can be carried out with good accuracy while curtailing increased costs.

Means for Solving Problem

The technological means devised to solve the above described problems involves, for a seat load detecting apparatus for detecting, by a load detection means, a load acting on a seat, arranging a latching rod for latching a plurality of cushion springs, that give cushioning in the seat, to the inside of a seat cushion frame that forms a seat skeleton, the load detecting means being arranged between the latching rod and the seat cushion frame.

In such cases, the load detecting means may preferably be arranged as a pair with respect to the latching rod.

Furthermore, the load detecting means may be formed from a flexible member that is equipped with a load sensor, one end of the flexible member being supported by the seat cushion frame, and the latching rod being supported rotatably by the other end.

In addition, the load detecting means may have the load sensor provided internally and may be formed from a cylinder whose internal volume is variable, one end of the cylinder being supported by the seat cushion frame and the rod being rotatably supported by the other end, the internal volume being variable when the load acts.

The load sensor is preferably configured so that the load is detected by detection by a Hall element, or by a variation in a resistive element.

Furthermore, the technological means devised to solve the above described problems may include a seat load detecting apparatus for detecting, by a load detection means, a load acting on a seat, comprising a seat cushion frame that forms a seat skeleton, a flexible member for engaging with the seat cushion frame, a latching rod for latching the flexible member, and a plurality of cushion springs that engage with the latching rod, wherein a load sensor is attached to the flexible member.

In this regard, the latching rod is preferably provided at at least one of the front and the rear of the seat cushion frame, and is preferably provided at one side or at both sides of the seat cushion frame.

Moreover, the cushion springs preferably have a waveform profile.

Furthermore, the technological means devised to solve the above described problems may include a seat load detecting apparatus for detecting, by a load detection means, a-load acting on a seat, comprising a seat cushion frame that forms a seat skeleton, a flexible member that engages with the seat cushion frame, a latching rod for latching the flexible member, and a plate member linked to the latching rod and receiving the load acting on the seat, wherein the flexible member is equipped with a load sensor.

In this regard, the latching rod is preferably provided at at least one of the front and the rear of the seat cushion frame, and is preferably provided at one side or at both sides of the seat cushion frame.

Moreover, the seat cushion frame and the plate member are preferably engaged by a spring.

In addition, the latching rod and the plate member are preferably engaged by a spring.

Effects of the Invention

According to a first characteristic configuration of the invention, it is possible to perform collective latching by the latching rod for latching the plurality of cushion springs that give cushioning, and the load thus collected can be enlarged. Moreover, in load detection, since the load detecting means need not be provided for each of the cushion springs, a configuration is possible in which load detection can be performed at low cost, and in comparison to conventional cases, load that escapes to the seat cushion frame is lessened and it is possible to perform load detection with good accuracy.

According to a second characteristic configuration of the invention, the load detecting means is provided as a pair with respect to the latching rod. As a result, it is possible to support the latching rod at two holding positions, and it is possible to detect the load acting on the latching rod by a summation of the pair of load detecting means.

According to a third characteristic configuration of the invention, the load detecting means is formed from the flexible member equipped with a load sensor, one end of the flexible member is supported by the seat cushion frame, and the latching rod is rotatably supported by the other end. As a result, the load acting on the plurality of cushion springs is collected by the latching rod, the load acting on the cushion springs can be communicated to the load detecting means without stress on the way to the load detecting means, and the load detection can be performed with good accuracy.

According to a fourth characteristic configuration of the invention, the load detecting means is provided internally with a load sensor and is formed from a cylinder whose internal volume is variable, one end of the cylinder is supported by the seat cushion frame, the rod is rotatably supported by the other end, and when a load acts, the internal volume varies. As a result, the load acting on the cushion springs is communicated to the load detecting means, and the internal volume of the cylinder can vary according to the size of the load. Furthermore, by the load sensor detecting the varying state of the internal volume, it is possible to perform load detection with good accuracy.

According to a fifth characteristic configuration of the invention, the configuration is such that the load sensor detects the load by detection by a Hall element or by a variation in a resistive element. As a result, it is possible to realize a simple configuration in which the Hall element is provided inside the cylinder, a permanent magnet is provided at a position opposite the Hall element, and variations in magnetic flux are detected by the Hall element, or, the resistive element is formed on the inside face of the cylinder, and a brush is made to slide on the resistive element according to the size of the load.

According to a sixth characteristic configuration of the invention, since the plurality of cushion springs are engaged with the latching rod, the load that bears on the cushion springs is collected in the latching rod. The load collected in the latching rod is transmitted to the flexible member, and is detected by the load sensor that is attached to the flexible member. As a result, it is not necessary to provide a load sensor at each cushion spring and an implementation can be realized at low cost. Furthermore, in comparison to conventional seat load detecting apparatuses, load that escapes to the seat cushion frame is lessened, and load detection can be performed with good accuracy.

According to seventh and eighth characteristic configurations of the invention, the latching rod is provided at at least one of the front and the rear of the seat cushion frame, or is provided at one side or at both sides of the seat cushion frame. As a result, a distortion due to the load assuredly occurs between the latching rod and the seat cushion frame.

According to a ninth characteristic configuration of the invention, since the cushion springs are engaged with the latching rods at equal intervals, the load bearing on the cushion springs is transmitted uniformly to the latching rod.

According to a tenth characteristic configuration of the invention, since the transmitted load is concentrated on a curved portion of the flexible member, the distortion occurs most easily in this curved portion. As a result, it is possible to accurately detect the load, through the load detection sensor provided at the curved portion.

According to an eleventh characteristic configuration of the invention, the load bearing on the seat can be widely collected by the cushion springs, that have a waveform profile.

According to a twelfth characteristic configuration of the invention, since a plate member is engaged with the latching rod, the load bearding on the plate member is collected at the latching rod. The load collected at the latching rod is transmitted to the flexible member, and is detected by the load sensor attached to the flexible member. As a result, the load bearing on the seat can be widely collected by the plate member. Furthermore, in comparison to conventional seat load detecting apparatuses, load that escapes to the seat cushion frame is lessened, and load detection can be performed with good accuracy.

According to thirteenth and fourteenth characteristic configurations of the invention, since the latching rod is provided at at least one of the front and the rear of the seat cushion frame, or is provided at one side or at both sides of the seat cushion frame, the distortion due to the load occurs assuredly, between the latching rod and the seat cushion frame.

According to fifteenth and sixteenth characteristic configurations of the invention, since the seat cushion frame and the plate member are engaged by means of a spring, or the latching rod and the plate member are engaged by means of a spring, cushioning can be increased.

Best Mode for Carrying Out the Invention

Embodiments of the present invention are explained below, referring to the figures. FIG. 1 is a perspective view showing a seat skeleton showing a configuration of a seat load detecting apparatus 10 for a vehicle, and FIG. 2 shows a situation where a seat skin and a headrest 5 are provided for the configuration shown in FIG. 1. Moreover, in the embodiments explained below, for the seat 1 shown in FIG. 2, for cases where a person sits normally on the seat pan 4, the forward side (left-hand side of FIG. 2) is taken as the front, the back side of the seat pan 4 (right-hand side of FIG. 2) is taken as the rear, and the two sides of the seat pan 4 are taken as the left and right sides.

As shown in FIG. 2, the seat 1 that is fixed to the floor of the vehicle via a bracket or the like, is mainly configured from a seat cushion 3 having the seat pan 4, a seatback 2, pivotable with respect to the seat cushion 3, at the rear of the seat pan 4, and a headrest 5 vertically moveable with respect to the seatback 2. The inside of the seat 1 is configured from a seat cushion frame 11 forming a skeleton for the seat cushion 3, and a seatback frame 12 forming a skeleton for the seatback.

The seat cushion frame 11 forming a seat skeleton for the seat pan 4 is made of a rigid body, with its inner portion exhibiting a rectangular shape and forming an opening. In the seat cushion frame 11, in order to maintain rigidity on the left and right of the rear of the seat pan 4, a linking rod 13 is arranged for both ends of the rear of the seat cushion frame 11.

Meanwhile, in order to provide cushioning in the opening 14 when a person sits on the seat cushion 3, a plurality of cushion springs 17 (for example, four springs in FIG. 1) exhibiting a waveform and having a prescribed spring constant, are arranged parallel to the left and right sides of the seat pan 4, and the configuration is such that load is received via the cushion springs 17. That is, one end of each of the cushion springs 17 is latched to the latching rod 15 provided at the front of the seat pan 4 such that the cushion springs are laid out and lined up at equally spaced intervals, and the other end of each of the cushion springs 17, which are lined up and laid out, is latched to the latching rod 16 provided at the rear of the seat pan 4. The latching rods 15 and 16, provided at the front and rear, exhibit pipe shapes of the same length and the same diameter, and are a little shorter than the length of the left and right sides of the opening 14. The ends of the cushion springs 17, which exhibit an approximate U-shape, are each caught onto, and are latched at prescribed positions on the latching rods 15 and 16. One of either of the latching rods 15 and 16 may alone be latched, or the latching rods 15 and 16 may be latched to one side or both sides of the seat cushion frame 11.

The latching rod 15 is supported by the seat cushion frame 11 and attached, via the pair of flexible members 21 arranged at both left and right sides of the seat pan 4 at the front of the seat cushion frame 11.

The flexible members 21 (load detecting means at the front) detect a load at the front of the seat pan 4, and exhibit a shape shown in FIG. 3. The flexible members 21 have a single plate (for example a steel plate, or the like, of a prescribed thickness) curved into an approximate U-shape, forming a flexible region 25, to which a load sensor 8 is attached, an end of which is roll-formed into a cylindrical shape forming a cylinder 23, and a pin 22 is set up perpendicular to the horizontal face 24 of the U-shape. The cylinder 23 may be welded to the flexible region 25 so that the cylinder 23 does not deform when a load acts on the flexible members 21. Furthermore, as another method of forming the flexible members 21, it is possible to the flexible region 25, the cylinder 23 and the pin 22 are each provided separately, and are integrated by carrying out welding or the like.

In the flexible members 21, as shown in FIG. 5, the latching rod 15 is inserted through the cylinder 23, the pin 22 is inserted from below in an upward direction though a mounting hole arranged at a prescribed position near the periphery at the edge of the opening of the seat cushion frame 11, and by fixing the inserted pin 22 using a fixing member, such as a nut, from above, the flexible members 21 are attached to the seat cushion frame 11. In this case, the load sensor 8 for detecting a deformation of the flexible region 25 is attached to the flexible region 25. The approximately U-shaped flexible members 21 are equipped with a curved portion 21a, and the load sensor 8 is attached to the curved portion 21a. Here, the load sensor 8 may be attached to the inner side of the curved portion 21a, or may be attached to its outer side.

Meanwhile, the flexible members 31 are arranged between the linking rod 13 and the latching rod 16 provided at the rear of the seat pan 4. The flexible members 31 are arranged as a pair on both left and right sides of the seat pan 4 at the rear of the seat cushion frame 11, and it is possible to detect a load at the rear of the seat pan 4 by the pair of flexible members 31.

The flexible members 31 (load detecting means at the rear) exhibit a shape shown in FIG. 4. The flexible members 31 have a single plate (for example a steel plate, or the like, of a prescribed thickness) curved into an approximate U-shape, forming a flexible unit 35, to which a load sensor 9 is attached, both ends of which are roll-formed into cylindrical shapes, in the direction of the respective outer sides, forming cylinders 32 and 33. In this case, welding or the like may be carried out on the flexible unit 35 so that the cylinders 32 and 33 do not deform when a load acts. Furthermore, as another method of forming the flexible members 31, it is possible that the flexible unit 35 and the cylinders 32 and 33 are each made separately, and are integrated by carrying out welding or the like. In addition, the approximately U-shaped flexible members 31 are equipped with a curved portion 31a and the load sensor 9 is attached to the curved portion 31a. Here, the load sensor 9 may be attached to the inner side of the curved portion 31a, or may be attached to its outer side.

As shown in FIG. 5, the flexible members 31 are arranged at the rear of the seat cushion frame 11 and detect a load at the rear. In the flexible members 31, the latching rod 16 is inserted through the lower cylinder 33, and the linking rod 16 that is attached to the seat cushion frame 11 is inserted through the upper cylinder 32.

That is, the plurality of parallel cushion springs 17 have one end linked to the latching rod 15, and the other end linked to the latching rod 16, and the two latching rods 15 and 16 are supported at the front and rear by the pairs of flexible members 21 and 31 arranged on the left and the right sides. The state shown in FIG. 5 is maintained by the spring force of the cushion springs 17 (for example, a state, as shown in FIG. 5, in which the cushion springs 17 are pulled horizontally and stretched without vertical displacement, or a state in which there are no variations in the vertical position of the flexible regions 25 and 35 located on both sides of the cushion springs 17). In these cases, the front cylinder 23 rotatably supports the latching rod 15 inserted through the center of the cylinder 23, and in addition the rear cylinder 33 rotatably supports the latching rod 16, with respect to the seat cushion frame 11. In these cases, regarding the flexible member 31, the cylinder 32 through which the linking rod 13 is inserted is also rotatably supported. In these cases, the load sensor 9 for detecting deformations of the flexible region 35 is attached to the flexible region 35.

Next, operation for cases where a load acts on the seat are explained, referring to FIG. 6.

From the state shown in FIG. 5, when an occupant sits on the seat cushion 3 and a load acts on the cushion springs 17 as shown in FIG. 6 (for example, a vertical load), the load opposes the biasing force of the cushion springs 17 and the cushion springs 17 deflect downward. In these cases, by the entire latching rod 15, which links to and latches the plurality of cushion sprints 17, being pushed downwards, the latching rod 15 that is inserted through the cylinders 23 of the front flexible members 21 rotates in a clockwise direction with respect to the cylinder 23, with the point of fixation, by the pin 22 to the seat cushion frame 11, as center. In this way, the cylinder 23 of the flexible member 21 moves downward from the state shown in FIG. 5, according to the size of the load, and at the same time, the flexible region 25 opens out, and it is possible to detect, by the load sensor 8 fixed to the curved flexible region 25, the opened out displacement thereof.

Furthermore, at the same time at the rear of the seat pan 4, the latching rod 16 that latches the rear end of the plurality of cushion springs 17 and lays them in rows, as shown in FIG. 6, is pushed downwards by the load, from the state shown in FIG. 5. The cylinder 32 then rotates in a clockwise direction, with the cylinder 32 through which the linking rod 13 is inserted as the center. In this way, the cylinder 33 that supports, with the latching rod 16, the rear ends of the cushion springs 17 in the downward direction, by the elastic force of the flexible member 31, rotates in an anti-clockwise direction. The cylinder 33 of the flexible member 31 sinks, according to the size of the load, in a downward direction, the same as the load acting. At the same time, the flexible region 35 with the U-shape opens wide as shown in FIG. 6, and the displacement can be detected by the load sensor 9 attached to the flexible region 35. In this case, if the load sensors (for example, strain gauges or the like) 8 and 9, in which voltage output varies linearly according to the size of the load, are used, where, for example, the voltages outputted from the pair of load sensors 8 disposed at the front of the seat pan 4 are VFR and VFL, and the voltages outputted from the pair of load sensors 9 disposed at the rear are VRR and VRL, it is possible to detect the load acting on the seat pan 4 by conversion of the voltage, from the total voltage value V of the four load sensors 8 and 9 (=VFR+VFL+VRR+VRL).

Meanwhile, when the occupant leaves the seat cushion 3 and the load acting from above on the cushion springs 17 ceases to act, by means of the biasing force possessed by the cushion springs 17, the state shown in FIG. 6 returns to the state shown in FIG. 5.

In this way, for the configuration shown in FIG. 5, the flexible regions 25 and 35 oppose the biasing force in approximately the same direction as the input direction of the load on the cushion springs 17, and they displace. From this fact, by varying the spring constant of the flexible regions 25 and 35, it is easy to configure the displacement amount of the flexible regions 25 and 35 to be according to the size of the load. Furthermore, in this configuration it is possible to absorb the attachment tolerance of the seat cushion frame 11, the cushion springs 17 and the flexible members 21 and 31, by means of the flexible regions 25 and 35.

A structure for detecting the load acting on the seat pan 4, for the seat cushion frame 11, can obviously also be applied to the seatback frame 12 that forms the skeleton of the seatback 2, and more accurate load detection is possible at the seat backrest region as well. In these cases, with the plurality of cushion springs 17 provided in the front-rear direction for the seat pan 4 inside the seat cushion frame 11 and the cushion springs 20 having cushioning in the backrest region of the seatback frame 12 disposed in a left-right direction, comfort is improved. The plurality of cushion springs 20 (six in FIG. 1) disposed in parallel in the backrest region are configured to be laid out in rows and latched by two latching rods 18 and 19 that have functions similar to the latching rods 15 and 16. The two latching rods 18 and 19 use members 26 and 29, similar to the above, described flexible member 21 or 31, and by being latched from both left and right sides of the seatback frame 12, a configuration may be realized in which a load acting on the seatback is detected.

(Embodiment 2)

Next, a configuration of Embodiment 2 will be explained. Embodiment 2 concerns a modified example of FIG. 5 and the configuration is shown in FIG. 7.

In the configuration of Embodiment 1 shown in FIG. 5, in the flexible members 21 and 31 that support the cushion springs 17 in the seat pan 4 from the front and the rear, the load sensors 8 and 9 are respectively provided at the curved flexible regions 25 and 35 where load displacements occur easily; however, the load sensors 8 and 9 can also be provided at the horizontal region 24 that extends from the moveable regions 25 and 35. In these cases, Hall elements 36 and 37 for detecting variations in magnetic flux are fixed to one side of the horizontal region 24, and permanent magnets 38 and 39 that generate the magnetic flux are provided on the other side at positions respectively opposite the Hall elements 36 and 37. In this way, when a load acts on the cushion springs 17, the cushion springs 17 flex, states in which the flexible regions 25 and 35 open wide, as shown in FIG. 6, are detected by output from the Hall elements 36 and 37, and it is possible to detect the load acting on the seat cushion 3. In this configuration, since the Hall elements 36 and 37 and the permanent magnets 38 and 39 may be arranged for the flexible members 21 and 31, by means of a simple structure, the load on the seat pan 4 acting on the seat cushion 3 is collected by the latching rods 15 and 16, and the load detection can be performed by the Hall elements 36 and 37 that constitute the load detecting means.

(Embodiment 3)

Next, Embodiment 3 is explained, referring to FIGS. 8 through 10. Embodiment 1 and Embodiment 2 are configured so that detection of the two latching rods 15 and 16 is done by the flexure of the flexible members 21 and 31; however, Embodiment 3 is configured with piston-type load detecting apparatuses (load detecting means) 40 and 49 instead of the flexible members 21 and 31. That is, a front load acting on the seat pan 4 is detected by the load detecting apparatus 40 provided towards the front, and a rear load acting on the seat pan 4 is detected by load detecting apparatus 49 provided towards the rear.

As shown in FIG. 10, the load detecting apparatus 40 is configured from a principal member 41 that forms a base, a moveable member 42 that has a cylinder 48 extensible and contractible in one direction with respect to the principal member 41, a spring 43 disposed between the principal member 41 and the moveable member 42, and a Hall element 44 and a permanent magnet 45 arranged inside a space, formed by the principal member 41 and the moveable member 42, whose internal volume is variable, the moveable member 42 being extensible and contractible only for a prescribed volume (a prescribed stroke) with respect to the principal member 41.

By the fact that the internal volume of the load detecting apparatus 40 is variable, and the fact that the distance between the permanent magnet 45 and the Hall element 44, provided, respectively, at the principal member 41 and the moveable member 42, varies according to the position of the moveable member 42 with respect to the principal member 41, and that the flux from the permanent magnet 45 that passes through the Hall element 44 varies, load detection from the displacement amount is possible. In such cases, by adjusting the height of the cylinder 48, it is possible to adjust the flux detected by the Hall element 44.

This type of load detecting apparatus 40 has a configuration in which, in the front, for example, the principal member 41 is fixed by a bolt or the like to the back of the periphery of the opening 14 of the seat cushion frame 11, and the latching rod 15 that receives the front load of the seat pan 4 is supported by the moveable member 42. Meanwhile, in the rear, as shown in FIG. 10, the cylinder 32 is formed integrally with the top of the principal member 41, the linking rod 13 is inserted through the cylinder 32, and the load detecting apparatus 40 is supported by the linking rod 13 so that it is rotatable with respect to the linking rod 13. Furthermore, the cylinder 33 is formed integrally with the bottom of the moveable member 42, and the latching rod 16 that collects the load acting on the cushion springs 17 is inserted therein.

Consequently, as shown in FIG. 9, if a load acts in the direction of the arrow on the cushion springs 17, due to this load the moveable member 42 of the load detecting apparatus 40 at the front extends only by an amount proportional to the size of the load, rather than the state shown in FIG. 8 (a state where a load is not acting on the cushion springs 17), and the extension displacement is detected by the Hall element 44. Furthermore, the moveable member 42 of the load detecting apparatus 49 at the rear, while rotating in a clockwise direction by means of the clockwise moment generated, extends only by an amount proportional to the size of the load, and this extension displacement is detected by the Hall element 44. In this way, the load acting on the cushion springs 17 can be detected by the sum of the outputs from the load detecting apparatuses 40 and 49 at the front and rear.

Furthermore, as another modified example, as shown in FIG. 11, a configuration may be realized such that, a cylinder 48 is formed at the moveable member 42, a resistive element 46, whose resistance value varies linearly in an axial direction along the inner wall of the cylinder 48, is installed integrally with the cylinder 48, a prescribed voltage (for example 5 V) is applied at both ends of the resistive element 46 via an external connector (not shown), a brush 47 that slides in an axial direction along the resistive element 46 is fixed in the center, inside the principal member 41, and by the moveable member 42 displacing in the axial direction with respect to the principal member 41, the displacement amount of the resistive element 46, that is, the load acting on the cushion springs 17, is detected.

(Embodiment 4)

Embodiment 4 is shown in FIG. 12.

In Embodiment 4, a load receiving plate 30, being a plate member formed of a rigid body, is arranged inside the seat cushion frame 11, and the load-receiving plate 30 is supported by each of a plurality of coil springs 27 and 28 from both the front and rear, with respect to the seat cushion frame 11. Even with a configuration in which in the rear, a load acting on the rear of the seat is received via the same latching rod 16 as in FIG. 1, it is possible to obtain the same effects as in Embodiment 1. In addition, the latching rod 16 may be latched on one side or on both sides of the seat cushion frame 11.

(Embodiment 5)

Embodiment 5 is shown in FIG. 13. In Embodiment 5, a configuration may be realized such that the cushion springs 17 and the latching rods 15 and 16 shown in FIG. 1 are collected into one load-receiving member 50 that possesses cushioning, and the load-receiving member 50 is supported by the flexible members 21 and 31 with respect to the seat cushion frame 11. In addition, the latching rods 15 and 16 may be latched on one side or on both sides of the seat cushion frame 11.

### INDUSTRIAL APPLICABILITY

In the field of vehicles, the invention is applicable in a seat load detecting apparatus in which a load sensor is arranged inside a frame constituting a seat skeleton.

### BRIEF DESCRIPTION OF DRAWINGS

FIG. 1 is a perspective view of a seat showing a configuration of a seat load detecting apparatus for Embodiment 1 of the seat load detecting apparatus of the invention;

FIG. 2 is a perspective view of the seat used in a vehicle;

FIG. 3 is a perspective view showing a form of a flexible member of which a pair are provided on the left and right at the front of a seat cushion frame shown in FIG. 1;

FIG. 4 is a perspective view showing a form of a flexible member of which a pair are provided on the left and right at the rear of the seat cushion frame shown in FIG. 1;

FIG. 5 is a pattern diagram showing a state where a load is not acting on a seat cushion, for the configuration shown in FIG. 1;

FIG. 6 is a pattern diagram showing a state where an occupant is seated on the seat cushion and a load is acting, for the configuration shown in FIG. 1;

FIG. 7 is a pattern diagram for Embodiment 2 of the present invention;

FIG. 8 is a pattern diagram for Embodiment 3 of the present invention;

FIG. 9 is a pattern diagram showing, with regard to FIG. 8, a state where a load is acting in the direction of the arrow;

FIG. 10 is a pattern diagram showing a configuration of a load sensor used in FIG. 8;

FIG. 11 is a pattern diagram showing another configuration of the load sensor used in FIG. 8;

FIG. 12 is a configuration diagram for Embodiment 4 of the present invention; and

FIG. 13 is a configuration diagram for Embodiment 5 of the present invention.

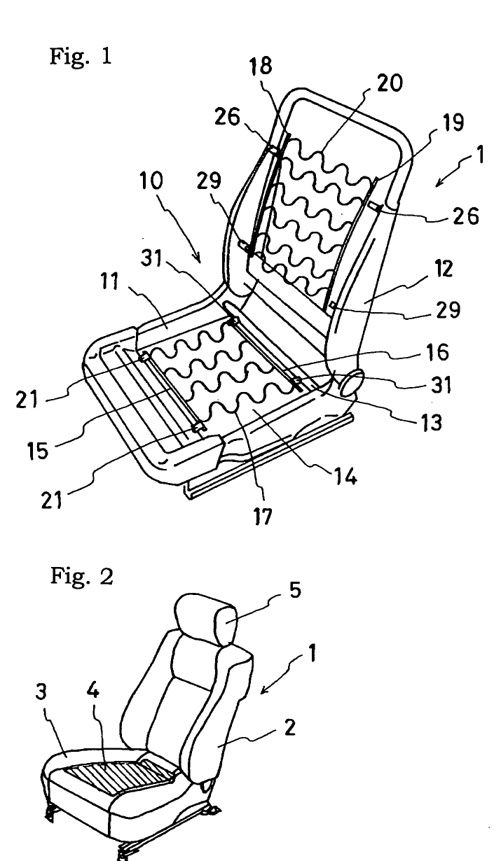

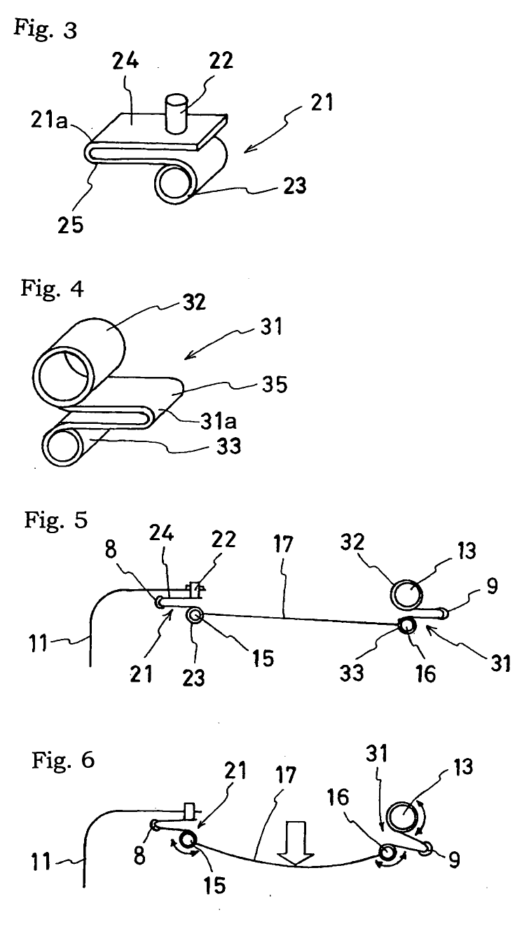

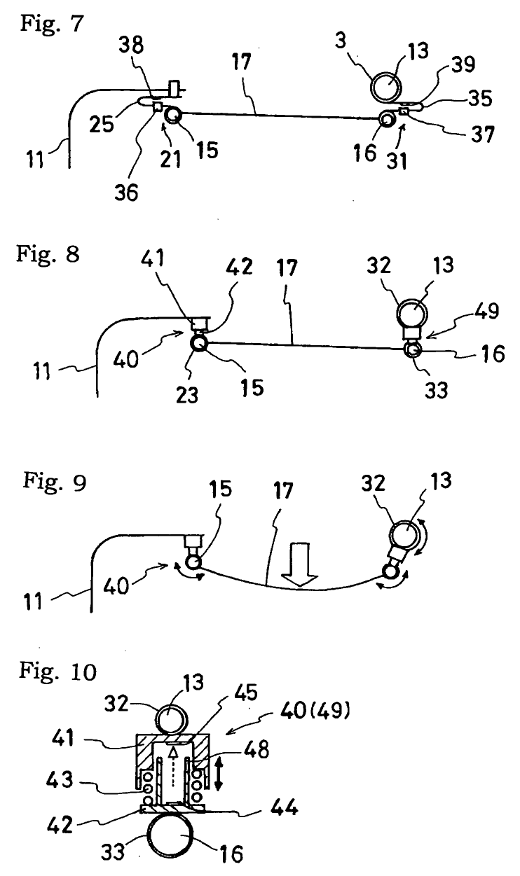

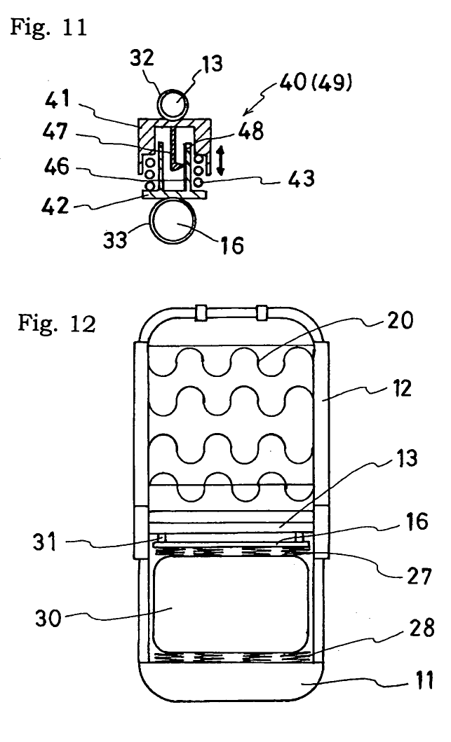

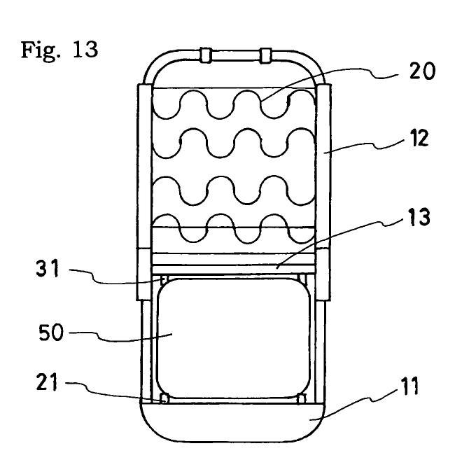

### EXPLANATION OF DENOTATIONS

1: seat
2: seatback
3: seat cushion
4: seat pan
8, 9: load sensor
10: seat load detecting apparatus
11: seat cushion frame
12: seatback frame
13: linking rod
15, 16: latching rod
17: cushion springs
21, 31: flexible member (load detecting means)
32, 34, 36, 37, 44: Hall element
33, 35, 38, 39, 45: permanent magnet
40: load detecting apparatus
41: principal member
42: moveable member
46: resistive element
47: brush

1. A seat load detecting apparatus for detecting a load acting on a seat by a load detecting means, wherein:
a latching rod for latching a plurality of cushion springs that give seat cushioning is provided in a seat cushion frame that forms a seat skeleton, and
the load detecting means is arranged between the latching rod and the seat cushion frame.

2. The seat load detecting apparatus according to claim 1, wherein the load detecting means is provided as a pair with respect to the latching rod.

3. The seat load detecting apparatus according to claim 1, wherein the load detecting means is formed of a flexible member provided with a load sensor, one end of the flexible member being supported by the seat cushion frame, and the latching rod being supported rotatably by the other end.

4. The seat load detecting apparatus according to claim 1, wherein the load detecting means is provided internally with a load sensor, and is formed from a cylinder whose internal volume is variable, one end of the cylinder being supported by the seat cushion frame, the rod being rotatably supported by the other end, and the internal volume being variable when the load is acting.

5. The seat load detecting apparatus according to claim 4, wherein the load sensor detects the load by detection by a Hall element or by displacement of a resistive element.

6. A seat load detecting apparatus for detecting a load acting on a seat by a load detecting means, comprising:
a seat cushion frame forming a seat skeleton,
a flexible member engaged with the seat cushion frame,
a latching rod for latching the flexible member, and
a plurality of cushion springs that engage with the latching rod, wherein
a load sensor is attached to the flexible member.

7. The seat load detecting apparatus according to claim 6, wherein the latching rod is provided at at least one of the front and the rear of the seat cushion frame.

8. The seat load detecting apparatus according to claim 6, wherein the latching rod is provided at one side or at both sides of the seat cushion frame.

9. The seat load detecting apparatus according to claim 6, wherein the cushion springs are engaged with the latching rod at equally spaced intervals.

10. The seat load detecting apparatus according to claim 6, wherein the flexible member has a U-shape with a curved portion, the curved portion being provided with the load sensor.

11. The seat load detecting apparatus according to claim 6, wherein the cushion springs have a waveform shape.

12. A seat load detecting apparatus for detecting a load acting on a seat by a load detecting means, comprising:
a seat cushion frame forming a seat skeleton,
a flexible member engaged with the seat cushion frame,
a latching rod for latching the flexible member, and
a plate member linked to the latching rod and receiving the load acting on the seat, wherein
the flexible member is provided with a load sensor.

13. The seat load detecting apparatus according to claim 12, wherein the latching rod is provided at at least one of the front and the rear of the seat cushion frame.

14. The seat load detecting apparatus according to claim 12, wherein the latching rod is provided at one side or at both sides of the seat cushion frame.

15. The seat load detecting apparatus according to claim 12, wherein the seat cushion frame and the plate member are engaged by a spring.

16. The seat load detecting apparatus according to claim 12, wherein the latching rod and the plate member are engaged by a spring.
